(19) United States
(12) Patent Application Publication
(10) Pub. No.: US 2023/0083765 A1
(43) Pub. Date: Mar. 16, 2023

(54) DEVICE FOR CLEANING THE VENT OF A FORGING DIE AND METHOD FOR USING SAID DEVICE

(71) Applicant: SAFRAN AIRCRAFT ENGINES, PARIS (FR)

(72) Inventor: Laurent FERRER, MOISSY CRAMAYEL (FR)

(21) Appl. No.: 17/794,495

(22) PCT Filed: Jan. 18, 2021
(86) PCT No.: PCT/FR2021/050087

§ 371 Date: Jul. 21, 2022

(30) Foreign Application Priority Data
Jan. 22, 2020 (FR) FR2000590

(51) Int. Cl. B08B 3/12; B21C 35/06; B30B 15/00

(52) U.S. Cl. CPC B08B 3/12; B21C 35/06; B30B 15/0082

(57) ABSTRACT

A device for cleaning a vent of a first forging die suitable for receiving, between the first die and a second die, a metal blank to be shaped in order to produce a metal part, the device for cleaning including a pump for injecting an aqueous solution, suitable for injecting the aqueous solution into the vent, an ultrasound generator, suitable for generating ultrasound waves within the vent, an air intake suitable for ensuring a venting of the vent, and a valve system for alternately controlling at least the injection of aqueous solution and ultrasound and the venting of the vent.

### TECHNICAL FIELD OF THE INVENTION

The present invention relates to a device for cleaning the vent of a forging die to remove the residues that cause clogs in the vent. It also relates to a method for using this device for cleaning.

The invention has applications in the field of forging metal parts and, in particular, in the fields of die forging, stamping or extruding metal parts such as aeronautical turbomachine parts.

### TECHNOLOGICAL BACKGROUND OF THE INVENTION

The manufacture of metal parts via forging consists of shaping a piece of metal, called a blank, by means of a pair of dies closed and pressed against one another by means of a compression tool such as a press or a ram. Each one of the dies, generally metallic, comprises an external face intended to be in contact with the compression tool and an inner face intended to be in contact with the metal blank. The inner face of each die of the pair of dies generally comprises the imprint of the shape chosen for the metal part, the inner faces of the dies of a pair of dies being positioned facing one another, during the compression.

During the closing of one die on the other, it frequently occurs that, due to the geometries of the inner faces of the dies, air is trapped between the metal blank to be shaped and one of the inner faces of the dies (or even both faces). However, air is to a large extent uncompressible and, once the dies are closed, the inter-die space is hermetic. One or more pockets of air are then created between the metal blank and the die or dies. The presence of these air pockets radically modifies the stresses in the die and the flow of the heated metal blank between the dies, in the vicinity of said pockets, which can induce several problems. The air pockets can, for example, generate filling problems, which result in an incorrect geometry of the metal parts and therefore scrap, metallurgical risks due for example to a heating of the metal blank, risks of premature damage of the dies or of the imprints of the dies, etc. All of these problems have, of course, consequences on the cost and the timeframe for manufacturing.

In order to prevent the formation of these air pockets, it is known to machine one or more vents in at least one of the dies of the pair of dies. A vent is an orifice that passes through the wall of the die from one end to the other in order to allow for an evacuation of the air imprisoned between the two dies. An example of a pair of dies with a vent is shown in FIG. 1. In this example, the pair of dies 10 comprises:
a first die 11, or upper die, the inner face 11a of which is provided with a first imprint 13, and
a second die 12, or lower die, the inner face 12a of which is provided with a second imprint 14.

In this example, one of the dies, for example the upper die 11, comprises a vent 20 that extends over the entire thickness of said die in such a way as to create an exhaust channel between the inner face 11a and the external face 11b of the die 11. This vent 20, generally carried out by piercing, comprises an air inlet 21 opening onto the inner face 11a of the die 11, preferably at an air trapping location on the imprint (for example a location where the imprint forms an acute angle). The vent 20 also comprises an air outlet 22 opening onto the external face 11b of said die 11, which is a free surface without hindrance to the flow of the air.

To shape the metal blank, the two dies 11 and 12 are assembled and pressed against one another, for example by means of their side handles 30 or a press or a ram, etc. The air imprisoned between the metal blank and the dies 11, 12 at the time of the assembly of the dies can flow through the air inlet 21 of the vent 20 to the air outlet 22 of the vent then escape outside the die.

However, in industry, for reasons of productivity, the manufacture of parts via forging is carried out in a campaign, or series, of several parts (50, 100, 300, etc.) shaped one after the other with the highest frequency possible. During these forging campaigns, the vent tends to become clogged as the parts are produced by the accumulation of a mixture of residues coming from industrial operations and little by little loses its effectiveness. This mixture of residues can be constituted, according to the type of forging, of lubrication residues (for example coming from graphite or carbon deposits), of residues of oxides linked to the oxidation of the metal materials, of workshop dust, of particles linked to the metal wear of the dies, of particles linked to the metal wear of the metal blank to be shaped, of glassing residues (also called enamel), etc. It has been observed, for example, that a vent of a diameter comprised between 0.2 mm and 4 mm, the die of which is used to form via extruding Titanium alloy parts (for example TA6V) and on which is deposited a layer of lubricant (for example an aqueous solution with graphite) after each forging, becomes clogged after the second or third part forged.

The fact that the vent gradually clogs up during the production campaign influences the reproducibility of metal parts the shape of which differs as the campaign progresses. Indeed, during the forging, the various residues are driven by the flow of air into the vent where they accumulate little by little. This accumulation modifies the loss of load in pressure of the vent and reduces its effectiveness. The air is evacuated with difficulty, the spreading of the metal blank to be shaped is modified and the shape of the metal part obtained at the end of the forging is modified. FIG. 2 shows schematically an example of a vent 20 wherein residues 41 have accumulated, to the extent of forming a clog that makes it difficult, even impossible, for the flow of the air. The air flow defect creates, upstream from the accumulated residues, an air pocket 42 that induces all the risks and disadvantages already mentioned hereinabove for the case of dies without vents.

In order to prevent the vent from becoming clogged, it is known to increase the diameter of the vent in particular at its inlet on the inner face of the die, a large-diameter vent varying generally between 2 mm and 25 mm. However, this practice only delays the clogging which will in the end be formed. Furthermore, this practice has for effect to create a forged protuberance on the metal part. FIG. 3 diagrammatically shows an example of a metal part 40 shaped from a metal blank in a die 11. This example shows a protuberance 43 formed on the metal part 40 at the location of the mouth 21 of the vent 20 by the metal blank cast in the vent at the surface of the imprint. Such a protuberance, not only results in a loss of metal, but in addition causes a blocking of the part in the imprint, requires a shearing of the protuberance in the vent and weakens the die.

Another practice commonly used to prevent the clogging of the vent is to stop the forging between each manufacturing of a part in order to remove the clog of residues. This cleaning of the vent is generally carried out manually with a tool of the “pipe cleaner” type. However, such an intervention is long and dangerous for the safety and health of the operator. Indeed, in orderfor the metal blank to be able to be shaped, the forging is generally carried out at very high temperature (temperature of the blank greater than or equal to about 900° C. and temperature of the dies at about 300° C.). It is therefore difficult for the operator to intervene in complete safety to unclog the vent, in such conditions. Furthermore, due to its small diameter, the vent is often difficult to locate on a hot die, covered with lubricant, which has for effect that the intervention is relatively long. In addition, in light of the thermal conditions, the vapours coming from the materials and tools can hinder the visibility of the operator, further increasing the duration of the intervention. The productivity of the metal parts is therefore substantially reduced by these cleaning operations.

There is therefore a real need for a forging tool wherein the vents of forging dies can be cleaned without stopping the production of the metal parts and without decreasing productivity.

### SUMMARY OF THE INVENTION

To respond to the problems mentioned hereinabove of unclogging vents of forging dies without a loss of productivity, the applicant proposes a forging tool that comprises forging dies and a device for cleaning vents of dies by injection of an aqueous solution and ultrasound into each vent.

According to a first aspect, the invention relates to a device for cleaning a vent of a first forging die suitable for receiving, between said first die and a second die, a metal blank to be shaped in order to produce a metal part, said device for cleaning comprising:
a pump for injecting an aqueous solution, suitable for injecting the aqueous solution into the vent,
an ultrasound generator, suitable for generating ultrasound waves within the vent,
an air intake suitable for ensuring a venting of the vent, and
a valve system for alternately controlling at least the injection of aqueous solution and ultrasound and the venting of the vent.

This device for cleaning allows regular and easy cleaning of the vent of the die to remove the residues therefrom before the latter creates, by accumulation, a clog.

In addition to the characteristics that have just been mentioned in the preceding paragraph, the device for cleaning according to an aspect of the invention can have one or more additional characteristics among the following, taken individually or according to any technically permissible combination:
the vent extending between an inlet opening into the die and an outlet opening outside the die, the injection pump is installed at the outlet of the vent to spray the aqueous solution from the outlet to the inlet of said vent.
the device for cleaning includes an evacuation device suitable for evacuating, outside the vent, residues coming from the forging of the metal part, the evacuation of the residues being controlled, after the injection of aqueous solutions and ultrasound, by the valve system.
the evacuation device comprises an air blowing device installed at the outlet of the vent and ensuring an injection of air inside the vent from the outlet of said vent.
the evacuation device comprises a suction device installed at the outlet of the vent and ensuring a suction of the aqueous solution with the residues.
the ultrasound generator comprises a plurality of ultrasound transducers mounted axisymmetrically around the outlet of the vent.
the ultrasound generator comprises an annular ultrasound transducer, mounted, via a central opening, around the outlet of the vent.
the valve system comprises a first valve connected to the evacuation device, a second valve connected to the injection pump and a third valve connected to the air intake.
the aqueous solution injected by the injection pump comprises a corrosion inhibitor.
it comprises a pressure probe suitable for detecting the pressure of the injected aqueous solution, said probe being connected to an automatic processing system able to automatically control the valve system and the ultrasound generator.

Another aspect of the invention relates to a method for cleaning a vent of a forging die implementing the device defined hereinabove. This method comprises, at the end of an operation of forging a metal part, the following operations:
opening of the injection pump and starting of the ultrasound generator so as to insert aqueous solution and ultrasound into the vent,
after separating and detaching of the residues, closing of the injection pump and of the ultrasound generator and opening of the air intake.

This method has the advantage of being able to be implemented during an inter-operation period in such a way that it does not generate any loss of time and therefore no drop in productivity.

This method for cleaning can have one or more additional characteristics among the following, taken individually or according to any technically permissible combination:
it comprises, after closing of the injection pump and of the ultrasound generator, an operation of opening the evacuation device in order to evacuate the aqueous solution and the residues, said evacuation device being closed again before the opening of the air intake.
the opening/closing of the injection pump, the opening/closing of the evacuation device and the opening/closing of the air intake are controlled from a valve system wherein a first valve controls the evacuation device, a second valve controls the injection pump and a third valve controls the air intake.
it is implemented during an inter-operation period of setting up materials and tools required for the forging of the new metal part.
it is implemented at the end of each forging operation of a predefined series of metal parts.

### BRIEF DESCRIPTION OF THE FIGURES

Other advantages and characteristics of the invention shall appear when reading the following description, illustrated by the figures wherein:

FIG. 1, already described, shows a schematic cross-section view of an example of forging dies with a vent;

FIG. 2, already described, shows a schematic view of a metal part being forged when residues have accumulated in the vent;

FIG. 3, already described, shows a schematic view of a metal part being forged when the vent of the die is large in diameter;

FIG. 4 shows a schematic view of an example of a device for cleaning according to the invention;

FIG. 5 schematically shows the device for cleaning of FIG. 4 during different cleaning phases; and

FIG. 6 shows, in the form of a functional diagram, the various operations of the method of implementing the device for cleaning of FIG. 4.

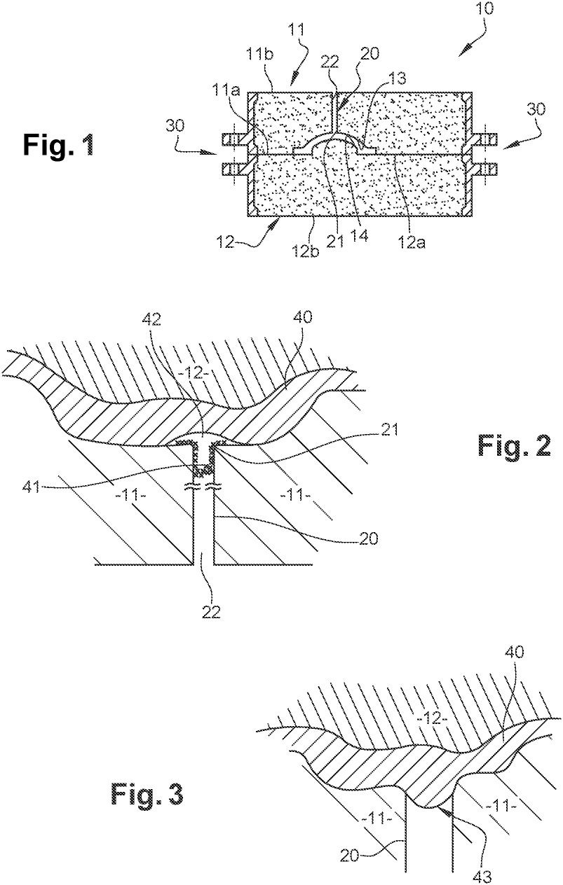

### DETAILED DESCRIPTION

An embodiment of a forging tool equipped with a device for cleaning the vent of a forging die, configured to prevent the formation of a clog in the vent and without effect on the productivity of the metal parts, is described in detail hereinafter, in reference to the accompanying drawings. This example shows the characteristics and advantages of the invention. Recall however that the invention is not limited to this example.

In the figures, identical elements are marked with identical references. With a concern for the legibility of the figures, the scales of size between the elements shown are not respected.

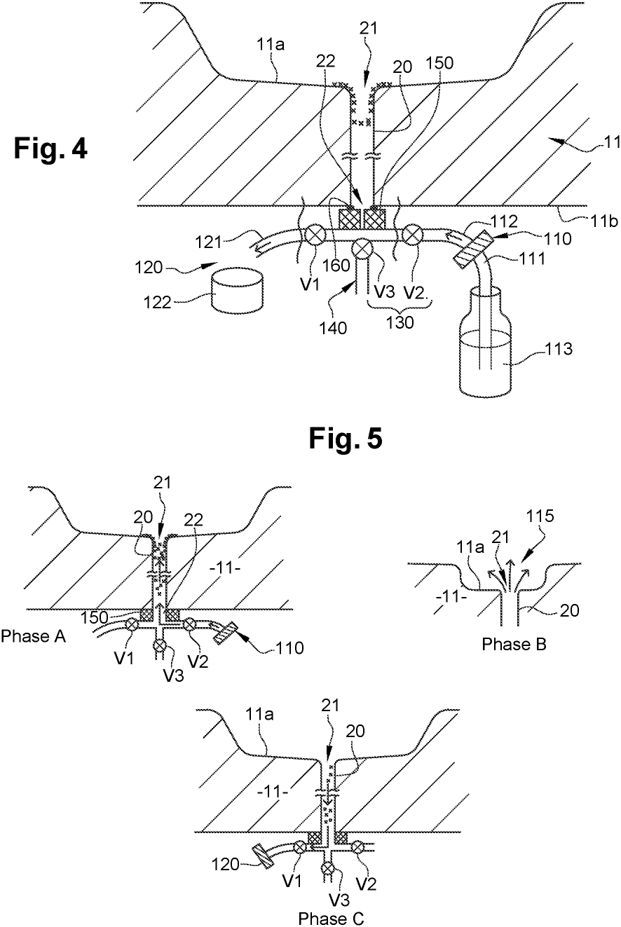

An example of a forging tool comprising forging dies and a device for cleaning the vents of these dies according to the invention is diagrammatically shown in FIG. 4, at the outlet of a vent of a forging die. As described hereinabove, the vent 20 can be carried out in the upper die or in the lower die. A vent - or several vents -can also be carried out in each one of the two dies of the pair of dies. In the example of FIG. 4, the vent 20 is carried out by piercing in the die 11 and extends in the entire thickness of the die, between the inner face 11a and the external face 11b of said die. Of course, the die can comprise several vents distributed at different locations of the imprint, each one of these vents being cleaned successively or simultaneously by the device for cleaning such as shall be described in what follows.

As shown in FIG. 4, the vent 20 comprises an air inlet 21 opening onto the inner face 11a of the die 11 and an air outlet 22 opening onto the external face 11b of said die and also called externally-opening end. The vent 20 can have varied forms such as, for example, a section with a varied shape (for example circular, square, triangular, etc.) or a varied dimension (for example a diameter comprised between 0.2 to 7 mm on the surface and, preferably, between 0.5 to 5 mm). The vent 20 can also have a section of which the shape and the dimension vary over the length thereof between its inlet 21 and its outlet 22.

The device for cleaning 100 the vent 20, more simply called device for cleaning, comprises an injection pump 110 suitable for injecting an aqueous solution into the vent 20. The injection pump 110 comprises:
a pipe for receiving 111 aqueous solution, connected to a container 113 containing the aqueous solution or to a source or to any other device making it possible to supply the injection pump 110 with aqueous solution,
a pipe for ejecting 112 aqueous solution, connected to the outlet 22 of the vent 20, via a valve system 130 described hereinafter, and
a set of components providing the pressurising of the aqueous solution in such a way that the aqueous solution injected into the outlet of the vent 20 via the ejection pipe 112 is at a pressure greater than the pressure of the aqueous solution in the receiving pipe 111.

The injection pump 110, of conventional design, has a capacity suitable for the quantity of aqueous solution that can be injected into the vent 20. This aqueous solution can comprise, in addition to water, compounds offering different properties that are advantageous for the cleaning of the vent, such as for example a solvent or an anti-scale compound. The choice of the detergent can depend in particular on the temperature of the blank and/or of the dies as well as the metal material of the vent. The aqueous solution can comprise, for example, a predefined content of a detergent such as glycol, alkaline sodium hydroxide, alcohol, non-ionic surfactants, alkaline surfactants, etc., which, through surfactant properties, participates in eliminating residues lodged in the vent. The proportion of detergent in the aqueous solution can vary, for example, between 2 and 10% by weight and, more advantageously, between 4 and 5%.

According to an alternative, the aqueous solution can include a corrosion inhibitor agent, such as for example amines, an alkali solution, ammonia, dechlorinated water, etc., which, when the die is metal, makes it possible to prevent any risk of rust forming inside the vent. This agent corrosion inhibitor can be mixed with the aqueous solution, more preferably basic (PH>7), with or without detergent.

Regardless of the aqueous solution chosen, said solution can be injected at ambient temperature, i.e. at the temperature of the location, generally a workshop. It can also vary, in relation to the ambient temperature, by a few degrees Celsius (in winter conditions, for example, by taking the precaution of not allowing the aqueous solution to freeze) up to about sixty degrees Celsius (in summer conditions, for example, in a forging workshop with surrounding ovens). Advantageously, it is possible to control the temperature of the aqueous solution between 20° C. and 60° C. and, advantageously, between 40° C. and 55° C.

In certain embodiments, the aqueous solution can be stirred, constantly or at regular intervals, for example by means of a mixer, so that the aqueous solution is homogeneous regardless of the compounds and/or agents present in said solution.

The injection pump 110 can be a conventional pump, accordingly sized, for example for the loss of load calculated in the ejection pipe and in the vent. According to non-exhaustive examples, the injection pump 110 can be chosen in such a way as to respond to the following properties:
Length equivalent to 1 m, pressure of 1.001 atmosphere with a flow rate of 10 I/h, the filling of the vent 20 taking place in less than 20 seconds; or
Length equivalent to 1 m, pressure of 1.017 atmosphere with a flow rate of 100 I/h, the filling of the vent taking place in less than 1.5 seconds; or
Length equivalent to 1 m, pressure of 2.35 atmospheres, with a flow rate of 500 I/h, the filling of the vent taking place in less than 0.25 seconds; or
Length equivalent to 1 m, pressure of 2.33 atmospheres with a flow rate of 1000 I/h, the filling of the vent taking place in less than 0.13 seconds.

In addition to the injection pump 110, the device for cleaning 100 also comprises an ultrasound generator 150, an evacuation device 120, an air intake 140 and a valve system 130. All of these devices can be mounted in a frame, for example movable and adapted to be displaced to the die or fixed and mounted on the external face of the die. Whether movable or fixed, this device for cleaning is designed to be installed at the outlet of the vent, i.e. at the externally-opening end of the vent.

The ultrasound generator 150 is a device that produces ultrasound making it possible to separate, from the walls of the vent 20, the residues coming from the forging of the metal part. The ultrasound generator generates ultrasound with successive compression and decompression phases. The decompression phases generate, in the aqueous solution, a multitude of microscopic bubbles. During the compression phase, the bubbles implode and cause, at the vent to be cleaned, turbulences that detach the residues from said vent. The ultrasound can be produced, for example, with a frequency comprised between about 25 and 90 kHz, in particular between 30 and 60 kHz, and more particularly between 40 and 50 kHz.

The ultrasound generator 150 can comprise at least two ultrasound transducers positioned axisymmetrically around the outlet 22 of the vent, for example fixed on the external face 11b of the die. Alternatively, the ultrasound generator 150 can comprise a single ultrasound transducer, of the annular type, positioned permanently or quasi-permanently around the outlet 22 of the vent, or fixed on the external face 11b of the die, or directly nested around the outlet of the vent.

The evacuation device 120 is a device provided to remove from the vent 20 the aqueous solution and residues separated by the aqueous solution with the addition of ultrasound. This evacuation device 120 includes an evacuation pipe 121 connected to the outlet of the vent 20 via a valve system 130 described hereinafter. The evacuation device 120 can include a tray 122 for retaining residues so as to recover said residues and the aqueous solution.

The air intake 140 is an air inlet pipe connected to the outlet of the vent 22 and opening to the open air. This air intake 140 ensures a venting of the vent 20 when the aqueous solution with the residues have been evacuated, this venting allowing the vent to dry before another metal part is forged.

The valve system 130 comprises several valves connected to one another and making it possible to alternatively control the injection of the aqueous solution with the ultrasound, the evacuation of residues and the venting of the vent. The valve system 130 comprises a first valve V1 connected to the evacuation device 120, a second valve V2 connected to the injection pump 110 and a third valve V3 connected to the air intake 140.

The second valve V2 is provided to control the opening or the closing of the ejection pipe 112 that connects the injection pump 110 to the vent 20. In particular, when the second valve V2 is closed, the injection pump 110 does not operate and when the second valve V2 is open, the injection pump operates and sends the aqueous solution into the vent 20.

The first valve V1 is provided to control the opening or the closing of the evacuation pipe 121 that connects the evacuation device 120 to the vent 20. In particular, when the first valve V1 is closed, the evacuation device does not operate and when the first valve V1 is open, the evacuation device 120 operates and evacuates the aqueous solution with the residues outside the vent 20.

The third valve V3 is provided to control the opening or the closing of the air inlet pipe that connects the air intake to the vent 20. When the third valve V3 is closed, no air enters into the vent and when the third valve V3 is open, air enters into the vent 20.

According to an embodiment, a single and same pipe is mounted in the outlet of the vent 20, this single pipe replacing the ejection pipe 112, the air inlet pipe and the evacuation pipe 121 in the portion located between the outlet of the vent 20 and the valve system 130. This pipe, as all the other pipes of the device for cleaning, can be for example a tube, a hose or any other closed conduit that can be inserted into the outlet of the vent 20 or fixed around the outlet of the vent 20 to ensure a passage of fluid - aqueous solution and/or air - between said vent and the device for cleaning. In the embodiment where a single pipe is connected to the outlet of the vent 20, this single pipe is connected to a “pipe node” serving the evacuation pipe 121 of the evacuation device 120, the air inlet pipe of the air intake 140 and the ejection pipe 112 of the injection pump 110. This embodiment has the advantage of allowing for a single connection of the device for cleaning onto the outlet of the vent 20 to carry out all the cleaning operations which shall be described hereinafter.

In an alternative, the outlet 22 of the vent is provided with a seal 160 that makes the junction hermetic between the pipe - for example the single pipe or the evacuation pipe, the air inlet pipe or the ejection pipe. This seal 160 is chosen to have properties and a stability compatible with the heating temperature of the die.

In certain embodiments, the evacuation device 120 comprises only one pipe allowing the residues driven by the aqueous solution to be evacuated outside the vent. In other embodiments, the evacuation device 120 comprises an air blowing device installed at the outlet of the vent 20, after the first valve V1. This blowing device is provided to inject a flow of air inside the vent from the outlet of said vent. This blowing device can include, for example, a blower pump sized by means of loss of load calculation. According to incomplete examples, the blower pump can be chosen to be stabilised in less than 1 s with a maintaining from 10 to 20 seconds and to respond to the following properties:
a blowing pressure of 140 kPa minimum and an airflow of 10 I/minutes over a length of 1 m; or
a blowing pressure of 200 kPa minimum and an air flow of 10 I/minutes over a length of 1 m; or
a blowing pressure of 142 kPa minimum and an airflow of 40 I/minutes over a length of 1 m.

According to an alternative, the injection pump 110 of the aqueous solution and the blower pump of the evacuation device 120 are the same pump suitable for switching from the aqueous solution to air and inversely. In this case, the valves V1 and V2 can be a single and same valve offering a closed position and two open positions, one for air, the other for the aqueous solution.

In yet other embodiments, the device for cleaning can include a suction device installed at the outlet of the vent 20, after the first valve V1, and ensuring a suction of the aqueous solution with the residues. According to incomplete examples, the suction device can be chosen in such a way as to be stabilised in less than 1 s with a maintaining from 10 to 20 seconds and to respond to the following properties:
a suction pressure of 40 kPa (vacuum of 110 kPa) and a flow rate of 10 I/minutes over a length of 1 m; or
a suction pressure of 40 kPa (vacuum of 110 kPa) and a flow rate of 40 I/minutes over a length of 1 m.

The embodiments where the evacuation device 120 comprises an air blowing device or a suction device have the advantage that the vent is dried before being reused for the forging of another part. It is therefore not necessary to treat the aqueous solution against scale.

In certain embodiments, the device for cleaning can be controlled manually by an operator who opens and closes the various valves V1, V2, V3 of the valve system 130 as the cleaning operations take place. The operator also ensures the control of the ultrasound generator by means of an on/off button. In other embodiments, all the valves of the valve system 130 are connected to an automatic processing system, such as for example a computer, that controls the openings and closings of the valves and the starting of the ultrasound generator according to predetermined timing data. In these embodiments, the operator controls only the beginning of the cleaning operations by pressing an on/off button. In yet other embodiments, a pressure probe housed, for example between the injection pump 110 and the air inlet 21, in particular between the second valve V2 and the air inlet 21, preferably close to said second valve V2. This pressure probe, suitable for detecting the pressure of aqueous solution injected into the vent 20, is connected to an automatic processing system (for example a computer) that automatically controls the various valves of the valve system 130 and the ultrasound generator, as soon as a predefined threshold pressure is detected.

The device for cleaning 100, such has just been described, can be implemented after each forging operation of a metal part or after a predetermined number of metal parts forged or each time that the operator deems necessary. Preferably, it will be implemented regularly during a part forging campaign, for example after the manufacture of 1 to 3 metal parts, in order to ensure a regular evacuation of the air at each forging operation.

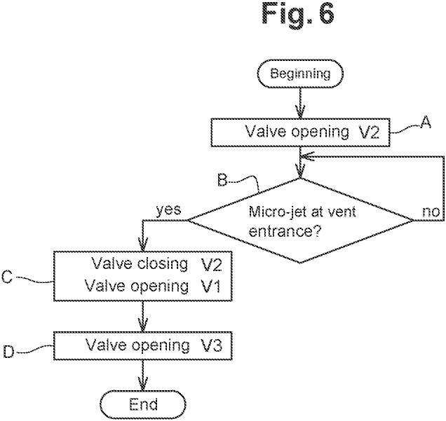

An example of a cleaning operation is shown in FIGS. 5 and 6. Immediately after the forging of a metal part, the device for cleaning 100 is actuated, either automatically or manually by the operator. The second valve V2 opens, ensuring the starting of the injection pump 110 and of the ultrasound generator 150. A predefined quantity of aqueous solution is then injected into the vent 20 and ultrasonic waves are pulsed into the aqueous solution inside the vent (phase A of FIG. 5). The aqueous solution and the ultrasonic waves act together to break up the blocking clog or the residues lodged in the vent and the accumulation of which would risk forming a blocking clog. The vent 20, filled with aqueous solution under pressure, acts as a vector of the waves. In the aqueous solution, the ultrasound waves successively trigger compression phases at the origin of the creation of small bubbles (cavitation) and of decompression phases during which the bubbles violently implode. Under the effect of the implosions of the bubbles, the particles of residues are separated and are detached from one another. When the aqueous solution comprises detergent, the detaching and the separation of the particles of residues are facilitated and accelerated. The duration of the breaking up of the residues is from about a few seconds to one minute.

Once the residues have been broken up, under the effect of the pressure and the ultrasound, a portion of the aqueous solution and residues are ejected in a micro-stream 115 by the inlet 21 of the vent, at the imprint (phase B of FIG. 5). The quantity of aqueous solution ejected by the inlet 21 is low in proportion to the quantity injected.

As soon as a micro-stream 115 of aqueous solution exits from the vent 20 through its inlet 21, the phase C of the cleaning is triggered. When the method is implemented manually by the operator, it is the operator who triggers the phase C by closing the second valve V2 and by opening the first valve V1, when they see a micro-steam of aqueous solution. When the method is implemented automatically, it is the drop in pressure in the vent that leads to actuating the closing of the second valve V2 and the opening of the first valve V1.

In the embodiments where the evacuation device 120 does not include a blowing device, or a suction device, the third valve V3 can be opened quickly after the opening of the first valve V1 (phase D) so that the air coming from the air intake 140 can enter into the vent 20 and dry said vent. The third valve V3 can be opened, for example, a few seconds (for example about ten seconds) after the first valve V1 has been opened. In the embodiments where the evacuation device 120 includes a blowing device or a suction device, the drying of the vent 20 is very fast and can be carried out in about ten seconds.

As soon as the cleaning operation is complete, the next operation of the forging campaign can be initiated, without a loss of time. In the embodiments where the device for cleaning is fixed to the die, the third valve V3 remains open during the forging operation, this valve V3 not only allowing for the passage of air from the air intake 140 to the vent 20, but also the passage of air from the vent 20 to the air intake 140. In other words, the fact that the third valve V3 is open allows the air enclosed between the two dies to be evacuated, via the vent 20, to the exterior of the dies and of the device for cleaning. In the embodiments where the device for cleaning is movable, it is sufficient to move the device for cleaning away from the die so that the vent again opens to the exterior. Thus, during the next forging operation, the air imprisoned between the dies will be evacuated by the vent directly to the exterior of the dies.

The cleaning operations implemented by the device for cleaning of the invention have the advantage of being able to be executed relatively quickly, without taking any time on the forging campaign. Indeed, between two forging operations, i.e. when a metal part has just been shaped and before the next part can be forged, several tasks must be executed by the operator such as taking out the shaped part, installing it in its rack, removing dust from the die, depositing a layer of lubricant on the internal face of the die, opening the oven, taking a metal blank and depositing it in the die, etc. These various “inter-operation tasks take a non-negligible and uncompressible amount of time. As the cleaning operations of the vent are relatively quick, they can become lodged during these inter-operation periods in such a way as to not disturb the duration of a forging campaign.

Although described through a certain number of examples, alternatives and embodiments, the device for cleaning the vent of a forging die according to the invention comprises various alternatives, modifications and improvements that will appear as evident to those skilled in the art, with the understanding that these alternatives, modifications and improvements are part of the scope of the invention.

1. A device for cleaning a vent of a first forging die suitable for receiving, between said first die and a second die, a metal blank to be shaped in order to produce a metal part, said device for cleaning comprising:
an injection pump for injecting an aqueous solution adapted to inject the aqueous solution into the vent,
an ultrasound generator adapted to generate ultrasound waves within the vent,
an air intake adapted to ensure a venting of the vent, and
a valve system adapted to alternately control at least the injection of aqueous solution and ultrasound and the venting of the vent.

2. The device for cleaning according to claim 1, wherein, the vent extending between an inlet opening inside the die and an outlet opening outside the die, the injection pump is installed at the outlet of the vent to spray the aqueous solution from the outlet to the inlet of said vent.

3. The device for cleaning according to claim 1, further comprising an evacuation device adapted to evacuate, outside the vent, residues coming from the forging of the metal part, the evacuation of the residues being controlled, after the injection of aqueous solutions and ultrasound, by the valve system.

4. The device for cleaning according to claim 3, wherein the evacuation device comprises an air blowing device installed at the outlet of the vent and ensuring an injection of air inside the vent from the outlet of said vent.

5. The device for cleaning according to claim 3, wherein the evacuation device comprises a suction device installed at the outlet of the vent and ensuring a suction of the aqueous solution with the residues.

6. The device for cleaning according to claim 1 , wherein the ultrasound generator comprises a plurality of ultrasound transducers mounted axisymmetrically around the outlet of the vent.

7. The device for cleaning according to claim 1 , wherein the ultrasound generator comprises an annular ultrasound transducer, mounted, via a central opening, around the outlet of the vent.

8. The device for cleaning according to claim 3 , wherein the valve system comprises a first valve connected to the evacuation device, a second valve connected to the injection pump and a third valve connected to the air intake.

9. The device for cleaning according to claim 1 , wherein the aqueous solution injected by the injection pump comprises a corrosion inhibitor.

10. The device for cleaning according to claim 1 , further comprising a pressure probe adapted to detect a pressure of the injected aqueous solution, said pressure probe being connected to an automatic processing system able to automatically control the valve system and the ultrasound generator.

11. A method for cleaning a vent of a forging die implementing the device according to claim 1, wherein, at the an end of an operation of forging a metal part, the method comprises:
opening of the injection pump and starting of the ultrasound generator so as to insert aqueous solution and ultrasound into the vent,
after separating and detaching of residues, closing of the injection pump and of the ultrasound generator and opening of the air intake .

12. The method for cleaning according to claim 11, further comprising, after closing of the injection pump and of the ultrasound generator, opening the evacuation device in order to evacuate the aqueous solution and the residues, said evacuation device being closed again before the opening of the air intake.

13. The method for cleaning according to claim 12, wherein the opening/closing of the injection pump, the opening/closing of the evacuation device and the opening/closing of the air intake are controlled from a valve system wherein a first valve controls the evacuation device, a second valve controls the injection pump and a third valve controls the air intake.

14. The method for cleaning according to claim 11 , wherein the method is implemented during an inter-operation period of setting up the materials and tools required for the forging of the new metal part.

15. The method for cleaning according to claim 11 , wherein the method is implemented at the end of each forging operation of a predefined series of metal parts.
